(19) United States
(12) Patent Application Publication
(10) Pub. No.: US 2025/0158797 A1
(43) Pub. Date: May 15, 2025

(54) METHODS AND APPARATUS FOR PERFORMING SELF-INTERFERENCE CANCELLATION IN A WIRELESS COMMUNICATION SYSTEM

(71) Applicant: Samsung Electronics Co., Ltd., Gyeonggi-do (KR)

(72) Inventors: Soomin KIM, Gyeonggi-do (KR); Yonghwi KIM, Seoul (KR); Chan-Byoung CHAE, Seoul (KR)

(73) Assignee: INDUSTRY-ACADEMIC COOPERATION FOUNDATION YONSEI UNIVERSITY, Seoul (KR)

(21) Appl. No.: 18/947,469

(22) Filed: Nov. 14, 2024

(30) Foreign Application Priority Data
Nov. 14, 2023 (KR) 10-2023-0157088

(51) Int. Cl. H04L 5/14; H04B 7/06; H04L 5/00

(52) U.S. Cl. CPC H04L 5/1438; H04B 7/0617; H04L 5/0051

(57) ABSTRACT

The disclosure relates to a 5^{th} generation (5G) or 6^{th} generation (6G) communication system in wireless communication. A method for a base station supporting flexible duplex communication by dynamically allocating uplink and downlink resources for the same frequency band in a wireless communication system includes transmitting a pilot signal for estimating non-linearity of an SI channel through which a signal transmitted by the base station is received by the base station; estimating non-linearity of the SI channel based on the pilot signal received through the SI channel; correcting and transmitting a DMRS, which is used for demodulating a signal received by a terminal from the base station, based on the estimated non-linearity of the SI channel; estimating the SI channel based on the corrected DMRS received through the SI channel; and performing communication with a plurality of terminals by cancelling SI based on the estimated SI channel.

### CROSS-REFERENCE TO RELATED APPLICATION(S)

The present application claims priority under 35 U.S.C. § 119 (a) to Korean Patent Application No. 10-2023-0157088, which was filed in the Korean Intellectual Property Office on Nov. 14, 2023, the entire disclosure of which is incorporated herein by reference.

### BACKGROUND

### 1. Field

The disclosure relates generally to a wireless communication system, and more particularly, to a method and apparatus for performing self-interference cancellation (SIC) by a base station in a wireless communication system.

### 2. Description of Related Art

Given the development of wireless communication over the years, technologies primarily for human-targeted services, such as voice, multimedia, and data, have been developed. Connected devices, which have grown exponentially since the commercialization of the fifth generation (5G) communication system, have been expected to be connected to a communication network. Such things connected to the network may be vehicles, robots, drones, home appliances, displays, smart sensors installed in various types of infrastructures, construction machines, factory equipment, and the like. Mobile devices are expected to evolve to various form factors, such as augmented reality (AR) glasses, virtual reality (VR) headsets, and hologram devices. In the sixth generation (6G), to provide various services through connection of hundreds of billions of devices and things with one another, efforts for developing an improved 6G communication system have been made. For this reason, the 6G communication system is referred to as a beyond 5G system.

In the 6G communication system that is expected to be realized around 2030, the maximum transmission speed is tera (i.e., 1,000 giga) bits per second (bps), and wireless latency is 100 microseconds (μ sec). That is, as compared with the 5G communication system, the transmission speed in the 6G communication system becomes 50 times faster, and the wireless latency is reduced to 1/10.

To achieve such a high data transmission speed and ultra-low latency, implementation of the 6G communication system in terahertz (THz) bands (e.g., 95 gigahertz (GHz) to 3 THz) bands is being considered. In the THz bands, due to more severe path loss and atmospheric absorption phenomena than those in the millimeter wave (mm Wave) bands introduced in the 5G, the importance of a technology to secure a signal reaching distance is expected to increase. As a primary technology to secure the coverage, it is required to develop a radio frequency (RF) element, antenna, a superior new waveform to the waveform of the orthogonal frequency division multiplexing (OFDM) in the coverage aspect, beamforming and massive multiple-input multiple-output (massive MIMO), full dimensional MIMO (FD-MIMO), array antenna, multi-antenna transmission technology, such as large scale antenna technique, and the like. In addition, to improve the coverage of the THz band signals, new techniques, such as metamaterial-based lens and antenna, high-level spatial multiplexing technology using orbital angular momentum (OAM), and reconfigurable intelligent surface (RIS), are being discussed.

For frequency efficiency enhancement and system network improvement, in the 6G communication system, developments are under way in a full duplex technology in which an uplink (UL) and a downlink (DL) simultaneously utilize the same frequency resource, a network technology to integrally utilize a satellite and high-altitude platform station (HAPS), a network structure innovation technology to support a mobile base station and to enable network operation optimization and automation, a dynamic spectrum sharing technology through collision avoidance based on spectrum usage prediction, an artificial intelligence (AI)-based communication technology to realize system optimization by utilizing AI from a design stage and internalizing end-to-end AI support function, and a next-generation distributed computing technology to realize services having complexity that exceeds the limit of the terminal operation capability by utilizing ultra-high performance communication and computing resources such as mobile edge computing (MEC) or cloud.

Attempts persist to further strengthen connectivity between devices by designing a new protocol to be used in the 6G communication system, implementation of hardware-based security environment, development of a mechanism for safe utilization of data, and technical development of a privacy maintaining method, to further optimize the network, to accelerate softwarization of network entities, and to increase openness of the wireless communication.

By such research and development of the 6G communication system, it is expected that the next hyper-connected experience will be possible through hyper-connectivity of the 6G communication system including not only connection between things but also connection between a human and a thing in all. Specifically, it is expected that services, such as truly immersive extended reality (XR), high-fidelity mobile hologram, and digital replica, can be provided through the 6G communication system. Since services, such as remote surgery, industrial automation, and emergency response through increasing security and credibility, are provided through the 6G communication system, the 6G communication system will be applied to various fields, such as industry, medical treatment, automobile, and home appliances.

Wireless communication methods may be divided into simplex, half-duplex, and full-duplex transmission methods, depending on the direction of data transmission and reception, and whether data may be transmitted and received simultaneously.

A simplex transmission scheme is a method in which the flow of data is limited to one direction, so only one-way transmission or reception is possible. For example, data such as sound or image may be received through television (TV) and radio, but data such as sound or image may not be transmitted through TV or radio. In this respect, TV and radio may be regarded as devices that support the simplex transmission scheme.

A half-duplex transmission scheme is a two-way communication that may transmit and receive in both directions, but a transmission scheme is configured so that transmission may not simultaneously occur on both sides. In other words, when a device that supports the half-duplex scheme is used, both transmission and reception are possible, but reception does not occur when transmitting, and transmission does not occur when receiving. For example, a master-slave type sensor network uses the half-duplex transmission scheme.

A full-duplex transmission scheme is a communication method in which two UEs use independent lines simultaneously to transmit and receive data. For example, telephone networks and high-speed data communications use the full-duplex transmission scheme.

The beamforming technology is classified into analog beamforming, digital beamforming, and hybrid beamforming that appropriately mixes analog beamforming and digital beamforming. The analog beamforming uses a transmission and reception system structure constituted with one RF chain and a plurality of phase shifters and signal attenuators, and forms the direction and shape of the beam by changing the phase and amplitude values of the phase shifter and signal attenuator connected to each individual antenna.

The digital beamforming technology uses a structure in which RF chains are connected to each individual antenna. RF circuits such as phase shifters or signal attenuators are not used. The digital beamforming techniques based on this system structure do not change the phase and amplitude of the signal at the RF stage, but change the phase and amplitude of the signal through digital signal processing at the baseband. In addition, the phase and amplitude of each signal heading to all antennas from a digital part may be individually controlled, which theoretically has the advantage of being able to simultaneously create the same number of beams as the number of antennas.

The hybrid beamforming technology uses fewer RF chains than the number of antennas and a structure that may simultaneously utilize a digital beamformer in the baseband and an analog beamformer in the RF band. This technology appropriately utilizes some of the structures of analog beamforming and existing digital beamforming technology. This hybrid beamforming scheme is characterized in taking advantage of reducing the number of RF chains to improve the system volume and power consumption issues of existing digital beamforming.

As described above and with the development of wireless communication systems, various services have been provided. Thus, there is a need in the art for schemes that smoothly and reliably provide these services. Specifically, in wireless communication systems that support full duplex transmission, various interferences caused by transmission and reception signals between terminals and base stations can be problematic. Thus, there is a need in the art for interference cancellation methods for more reliably providing these services.

### SUMMARY

The disclosure has been made to address at least the above-mentioned problems and/or disadvantages and to provide at least the advantages described below.

Accordingly, an aspect of the disclosure is to provide a method and apparatus for performing SIC in a mobile communication system.

An aspect of the disclosure is to provide a method for performing SIC in flexible duplex communication, which is a communication method capable of controlling the bands of the UL and DL in the same time slot.

An aspect of the disclosure is to provide a method for estimating a self-interference (SI) channel by using a method for separately estimating the non-linearity of the SI channel in a mobile communication system, to more efficiently perform SIC than in the prior art.

In accordance with an aspect of the disclosure, a method for a base station supporting flexible duplex communication by dynamically allocating UL and DL resources for the same frequency band in a wireless communication system includes transmitting a pilot signal for estimating non-linearity of an SI channel through which a signal transmitted by the base station is received by the base station; estimating non-linearity of the SI channel based on the pilot signal received through the SI channel; correcting and transmitting a demodulation reference signal (DMRS), which is used for demodulating a signal received by a terminal from the base station, based on the estimated non-linearity of the SI channel; estimating the SI channel based on the corrected DMRS received through the SI channel; and performing communication with a plurality of terminals by cancelling SI based on the estimated SI channel.

In accordance with an aspect of the disclosure, a base station supporting flexible duplex communication by dynamically allocating UL and DL resources for the same frequency band in a wireless communication system includes a transceiver; and a controller coupled with the transceiver and configured to transmit a pilot signal for estimating non-linearity of an SI channel through which a signal transmitted by the base station is received by the base station, estimate non-linearity of the SI channel based on the pilot signal received through the SI channel, correct and transmit a DMRS, which is used for demodulating a signal received by a terminal from the base station, based on the estimated non-linearity of the SI channel, estimate the SI channel based on the corrected DMRS received through the SI channel, and perform communication with a plurality of terminals by cancelling SI based on the estimated SI channel.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a flexible duplex communication technology in a wireless communication system according to an embodiment;

FIG. 2 illustrates when a base station and a plurality of user equipments (UEs) communicate using a flexible duplex communication method in a wireless communication system according to an embodiment;

FIG. 3 illustrates various forms of interference occurring in a wireless communication system according to an embodiment;

FIG. 4 illustrates SI occurrence and SIC in a sub-band full duplex (SBFD) communication situation in a wireless communication system according to an embodiment;

FIG. 5 illustrates a line of sight (LoS) SI channel and a non-LoS (NLoS) SI channel in a wireless communication system according to an embodiment;

FIG. 6 illustrates an SI channel in a time domain and a frequency domain in a wireless communication system according to an embodiment;

FIG. 7 illustrates non-linearity occurring in a nonlinear element of a transmitter of the base station in a wireless communication system according to an embodiment;

FIG. 8 illustrates a process in which SI including non-linearity occurs in a wireless communication system and a process for estimating a non-linearity of an SI channel according to an embodiment;

FIG. 9 illustrates a flowchart for a base station to communicate with a UE by cancelling SI in a wireless communication system according to an embodiment;

FIG. 10 illustrates a flowchart of a UL beam selection and a DL beam selection operations in a wireless communication system according to an embodiment;

FIG. 11 illustrates a flowchart of an operation for estimating a non-linearity of an SI channel in a wireless communication system according to an embodiment;

FIG. 12 illustrates a form of a pilot signal according to an embodiment;

FIG. 13 illustrates a process for deriving the non-linearity of a pilot signal according to an embodiment;

FIG. 14 illustrates various forms of pilot patterns according to an embodiment;

FIG. 15 illustrates a flowchart of an SI channel estimation operation in a wireless communication system according to an embodiment;

FIG. 16 illustrates an entire process of estimating non-linearity of a pilot signal and estimating an SI channel based on the same in a wireless communication system according to an embodiment;

FIG. 17 illustrates a structure of a UE in a wireless communication system according to an embodiment; and

FIG. 18 illustrates a structure of a base station in a wireless communication system according to an embodiment.

### DETAILED DESCRIPTION

The following description with reference to the accompanying drawings is provided to assist in a comprehensive understanding of the disclosure. It includes various specific details to assist in that understanding but these are to be regarded as merely examples. Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Terms to be described hereafter have been defined by taking into consideration functions in the disclosure, and may be different depending on a user or an operators intention or practice. Accordingly, they should be defined based on contents over the entire specification.

Hereinafter, a base station is a subject performing resource allocation of a UE, and may be at least one of a gNode B, an eNode B, a Node B, a BS, a wireless access unit, a base station controller, and a node on a network. A terminal may include a UE, a mobile station (MS), a cellular phone, a smart phone, a computer, or a multimedia system capable of performing communication functions. A DL is a wireless transmission path of a signal transmitted from a base station to a UE, and the UL is a wireless transmission path of a signal transmitted from a UE to a base station. Although the disclosure will be described as an example of a long term evolution (LTE) or LTE-advanced (A) system, the disclosure may also be applied to other communication systems having a similar technical background or channel form. For example, 5G mobile communication technology (5G, new radio (NR)) developed after LTE-A may be included, and 5G below may also be a concept that includes existing LTE, LTE-A, and other similar services. In addition, the disclosure may be applied to other communication systems through some modifications within the scope of the disclosure as determined by the judgment of one skilled in the art.

Additionally, it will be understood that singular expressions such as “a” and “the above” include plural expressions, unless the context clearly dictates otherwise in an embodiment of the disclosure. Alternatively, terms including ordinal numbers, such as first, second, and the like may be used to describe various components, but the components may not be limited by the terms. The terms are used only for the purpose of distinguishing one component from another component. For example, a first component may be referred to as a second component, and similarly, a second component may be referred to as a first component, without departing from the scope of the disclosure. In addition, as used herein, the term “and/or” may include a combination of a plurality of related described items, or any item among a plurality of related described items.

A singular expression may include a plural expression unless it is explicitly meant differently in the context. In the specification, it should be understood that terms such as “including” or “have” may be intended to designate that a feature, a number, a step, an operation, a component, a part, or combinations thereof described in the specification exist, and may not pre-preclude the presence or additional possibility of one or more other features or a number, a step, an operation, a component, a part, or any combination thereof. In addition, terms such as “associated with” and “associated therewith” and derivatives thereof may refer to terms such as include, be included within, interconnect with, contain, be contained within, connect to or with, couple to or with, be communicated with, cooperate with, interleave, juxtapose, be proximate to, be bound to or with, have, have a property of, and the like. In addition, the term report may be used with the same meaning as transmit.

A pilot signal in the disclosure may be used interchangeably with the same meaning as a reference signal. A transmitter of the base station in the disclosure may be used interchangeably with the same meaning as Tx, and a receiver of the base station may be used interchangeably with the same meaning as Rx.

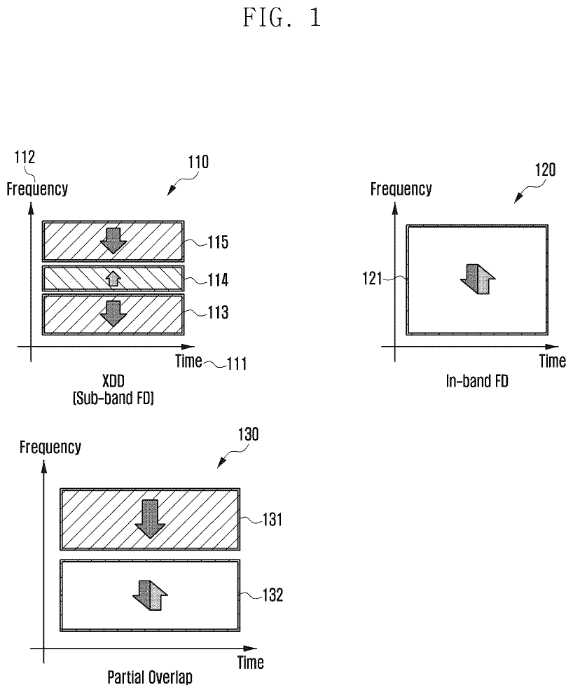

Although LTE-, LTE-A-, NR, or 6G-based system is described in connection with various embodiments of the disclosure, as an example, various embodiments of the disclosure may also apply to other communication systems with similar technical background or channel form. Embodiments of the disclosure may be modified in such a range as not to significantly depart from the scope of the disclosure under the determination by one of ordinary skill in the art and such modifications may be applicable to other communication systems. FIG. 1 illustrates a flexible duplex communication technology in a wireless communication system according to an embodiment.

Referring to FIG. 1, a horizontal axis 111 represents a time domain or time zone, and a vertical axis 112 represents a frequency domain or frequency band.

In the disclosed flexible duplex communication technology, a base station dynamically allocates UL and DL resources for the same frequency band in a specific time zone to communicate. When flexible duplex communication is used, efficient communication may be enabled by increasing the utilization of the frequency band.

The flexible duplex communication may encompass cross division duplex (XDD) 110, inband full-duplex (IBFD) 120, and partial IBFD (partial overlap) 130. XDD 110 communication technology enables communication to be performed with a UE by dividing a specific frequency band of a specific time zone into sub-bands for UL or DL transmission, which is the same concept as SBFD communication. For example, in a base station supporting XDD communication, a part of the DL frequency band may be adjusted to be used for UL transmission for a frequency band for DL transmission of a specific time zone, thereby supporting communication with a UE.

The XDD 110 illustrates that some 114 of the bands allocated for DL transmission in XDD communication are adjusted to be used for UL transmission. For example, the reference numeral 110 illustrates that all frequency bands corresponding to bands 113, 114, and 115 of a specific time zone which are initially configured as frequency bands of a specific time zone used for DL transmission, but a base station supporting XDD communication may have adjusted some bands 114 to be used for UL transmission. Therefore, the frequency bands 113 and 115 may be used for DL transmission in a specific time zone, and the frequency band 114 may be used for UL transmission in a specific time zone.

The IBFD 120 technology enables communication to be performed with a UE by freely overlapping UL and DL in an entire specific frequency band in a specific time zone. For example, IBFD 120 is when a frequency band in a specific time zone that has been initially configured to be used for DL transmission, but a base station supporting IBFD communication may have adjusted the IBFD 120 so that it may be used for both UL and DL transmissions. Therefore, frequency band 121 may be used for both UL transmission and DL transmission in a specific time zone.

A partial IBFD 130 technology (or partial overlap) enables communication to be performed with a UE by freely overlapping UL and DL in some bands of a specific frequency band in a specific time zone. For example, the partial overlap 130 is when it has been initially configured as a frequency band for a specific time zone used for DL transmission, but a base station supporting partial IBFD communication may have adjusted some of the bands so that they may be used for both UL and DL transmissions. Accordingly, frequency band 132 is used for both UL and DL transmissions in a specific time zone, and frequency band 131 is used for DL transmission in a specific time zone.

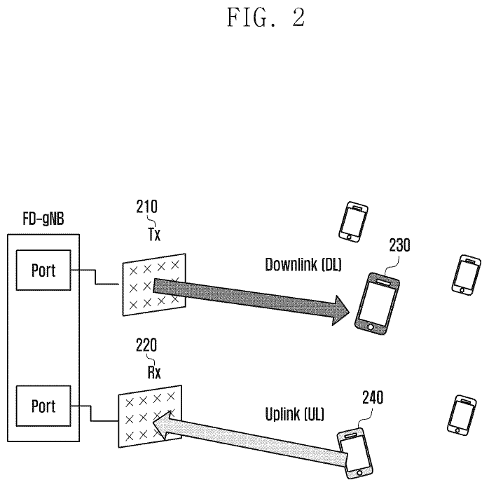

FIG. 2 illustrates when a base station and a plurality of UEs perform communication in a wireless communication system according to an embodiment.

Referring to FIG. 2, a base station may include a transmitter (Tx) of the base station 210 and a receiver (Rx) of the base station 220. The base station may select various duplex communication modes according to users in a cell and the scheduling result. For example, the base station may support any flexible duplex communication among XDD communication, IBFD communication, or partial IBFD communication.

The base station supporting flexible duplex communication may be connected (or paired) with at least one of a first UE 230 and a second UE 240. For example, among the plurality of UEs, the first UE 230 may be connected to the transmitter of the base station and may receive a DL signal from the base station, and the second UE 240 may be connected to the receiver of the base station and may transmit an UL signal to the base station. The connection between the base station and the first UE and the second UE may be performed through a beam selection process, and the detailed connection process will be described later.

The base station in FIG. 2 may perform communication with the UE through MIMO, in which data transmission and reception efficiency may be improved by adopting multiple transmission antennas and multiple reception antennas for data transmission and reception, departing from an existing single input single output (SISO) scheme that has performed communication using one reception antenna and one transmission antenna. By using the MIMO technology, effects such as reduced fading effects, large capacity, high speed, and increased coverage may be obtained, and channel capacity may be increased without increasing frequency bandwidth and transmission power, and when OFDM technology is incorporated, the transmission rate may be increased and transmission data may be mass-produced.

The base station in FIG. 2 may also perform beamforming technology, which focuses radio signals in a specific direction by changing the amplitude and phase of signals supplied to multiple antennas from both a mobile device and a network base station. In other words, beamforming focuses radio waves to a specific location to create a beam to increase efficiency. By focusing signals in this manner, communication may be performed efficiently without amplifying transmission power.

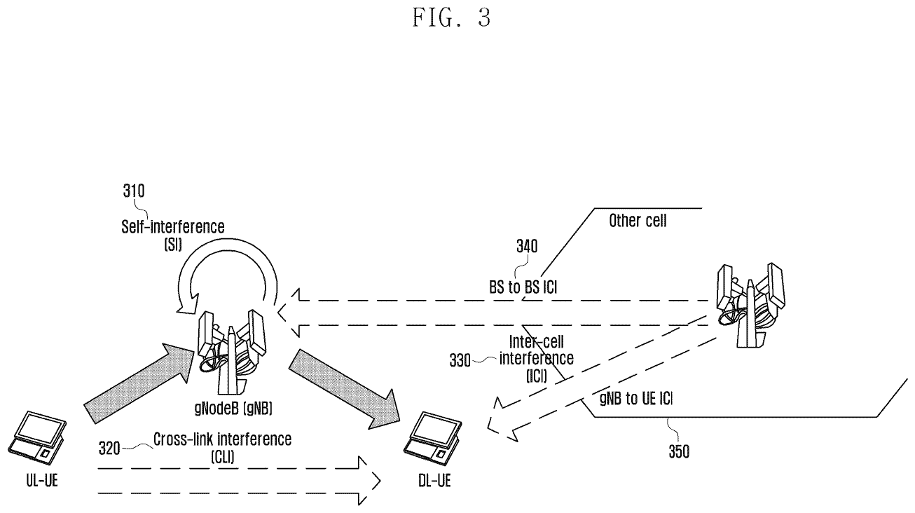

FIG. 3 illustrates various forms of interference in a wireless communication system according to an embodiment.

Interference is a property of fluctuations, and may include constructive interference in which fluctuations increase depending on location when two or more fluctuations of the same frequency propagate in space while changing the direction or phase. Destructive interference in which waves decrease depending on location when two or more waves of the same frequency propagate in space. Since a wireless communication system has the characteristic of transmitting and receiving radio waves wirelessly, various forms of interference may exist. A base station and UE may select a wireless communication scheme by considering various forms of interference.

Referring to FIG. 3, there may exist SI 310 causing interference between specific components of the same base station, cross-link interference (CLI) 320 in which a signal transmitted from one link of a network interferes with a signal from another link, and inter-cell interference (ICI) 330 causing interference between different cells may exist. Inter-cell interference may be classified into inter-cell interference between a base station and another base station (BS to BS ICI) 340 and inter-cell interference between a base station and a UE paired with another base station (gNB to UE ICI) 350. Cross-link interference between UEs may be somewhat difficult to be measured and reported.

In FIG. 3, when a base station supports flexible duplex communication, SI 310 in which a signal transmitted from a transmitter of the base station is received by a receiver of the base station may be a particular problem.

In using IBFD 120 or partial IBFD 130 communication that may freely overlap the UL and DL in all or part of a specific frequency band in a specific time zone to perform communication with a UE, SI may occur because the UL and DL overlap in a specific frequency in a specific time zone.

Even when XDD 110 communication is used where frequency bands of a specific time zone do not overlap, SI may occur due to inter-modulation distortion (IMD).

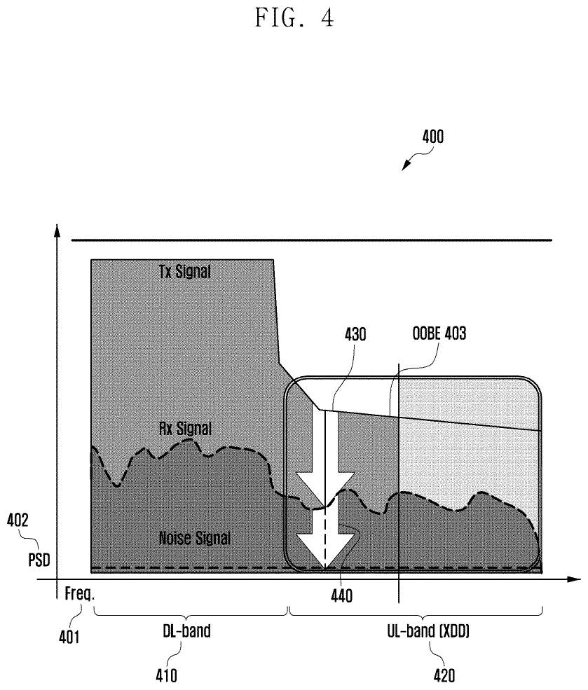

FIG. 4 illustrates SI occurrence and SIC in an SBFD communication situation 400 in a wireless communication system according to an embodiment.

When using flexible duplex communication, SI may occur regardless of which communication method is used, whether it is inband full duplex communication, partial inband full duplex communication, or XDD communication. As discussed above, the SI occurs between specific components of the same base station. For example, the SI may occur between a transmitter of the base station and a receiver of the base station when a signal transmitted by the transmitter of the base station to the UE is received by the receiver of the base station and acts as interference in UL communication. In this case, a channel or path through which the signal transmitted by the base station is received back by the base station may be the SI channel.

When conducting flexible duplex communication by dynamically allocating UL and DL resources for inband, SIC may be particularly necessary for smooth communication. SI cancellation is a process of cancelling SI, and may be classified into analog SIC and digital SIC.

The analog SIC is a method for minimizing the amount of SI received at the receiver of the base station by weakening the SI channel between the transmitter of the base station and the receiver of the base station as much as possible. Physical methods may be used to cancel the analog SI. For example, in a base station that uses beamforming technology to perform communication, a method for weakening the SI channel as much as possible by adjusting a beamforming direction (e.g., by adjusting the direction of the beamformed beam in the opposite direction) may be used. Another example is a method for weakening the SI channel as much as possible by using panel separation of the transceiver panels, such as placing a wall between the transmitter and receiver or increasing a distance between the transmitter and receiver as much as possible. By using the analog interference cancellation, SI may be cancelled to an extent.

The digital SIC may refer to estimating the SI channel and performing SIC based on the estimated SI channel. After performing the analog SIC, when the digital SIC is performed, most SI may be cancelled. In other words, the SI may be reduced to a noise level through the analog SIC and digital SIC.

Referring to FIG. 4, the situation 400 is a representation of a transmission signal (Tx signal) and reception signal (Rx signal) on the x-axis 401 of a frequency band and the y-axis 402 of a power spectrum density (PSD) in relation to a base station supporting XDD.

A frequency band 410 is scheduled so that a base station supporting numeral 420 is a frequency band 420 is scheduled so that a specific UE may transmit an UL to a base station supporting XDD communication. As described above, in XDD communication, even if the frequency band for UL transmission and the frequency band for DL transmission do not overlap, out of band emission (OOBE) 403 may occur due to IMD. Due to the out of band emission, a DL signal may be received by the receiver of the base station through the frequency band 420 adjusted to be used for UL transmission.

When the DL signal transmitted from the transmitter of the base station is received by the receiver of the base station through the adjusted frequency band 420, the received signal may act as SI. When the received signal acts as SI, it may interfere with the decoding of the UL signal by the receiver of the base station.

Signal 430 acting as SI is reduced through analog SIC. The power of the signal acting as the SI may be somewhat reduced by using the analog SIC.

The SI signal 440 after the analog SIC is reduced through the digital SIC. The power of the SI signal after the analog SIC may be reduced to a noise level through the digital SIC.

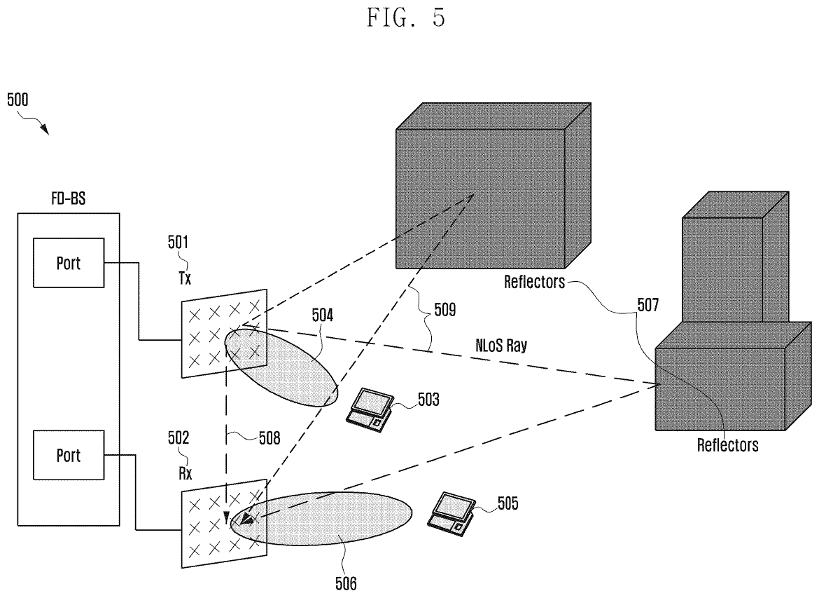

FIG. 5 illustrates a scenario 500 of an LoS SI channel and an NLoS SI channel in a wireless communication system according to an embodiment.

Referring to FIG. 5, the scenario 500 illustrates a Tx of the base station 501 supporting flexible duplex communication, an Rx of the base station 502, a first UE 503, a transmission beam 504 connected to the first UE, a second UE 505, a reception beam 506 connected to the second UE, reflectors 507, and a multi path SI channel including a LoS SI channel 508 and a NLoS SI channel 509. The reflectors 507 may be objects capable of reflecting all or part of a radio wave, such as a building, a tree, or a mountain.

The Tx of the base station 501 may transmit a DL using the transmission beam 504 formed through beamforming with the first UE 503, and the Rx of the base station 502 may receive an UL using the reception beam 506 formed through beamforming with the second UE 505. In this case, a transmission beam for servicing the UL and a reception beam for servicing the DL may be determined independently of each other.

Some of the beams transmitted by the transmitter of the base station 501 may reach the base station receiver 502 and act as SI. A path along which some of the beams transmitted by the transmitter of the base station reach the base station receiver may be referred to as an SI channel, and the SI channel may be a multi path, which may be referred to as a multi path SI channel. A multi path SI channel may include a LoS SI channel and a NLoS SI channel. As to the LoS SI channel, a signal transmitted from a transmitter of the base station reaches a receiver of the base station through a linear path. As to the NLoS SI channel, a signal transmitted from a transmitter of the base station reaches a receiver of the base station through at least one reflector. In addition, a channel that is not the LoS SI channel among the SI channels may be referred to as an NLoS SI channel. Since a SI channel generally has multiple paths, a multi path SI channel and an SI channel may be used interchangeably.

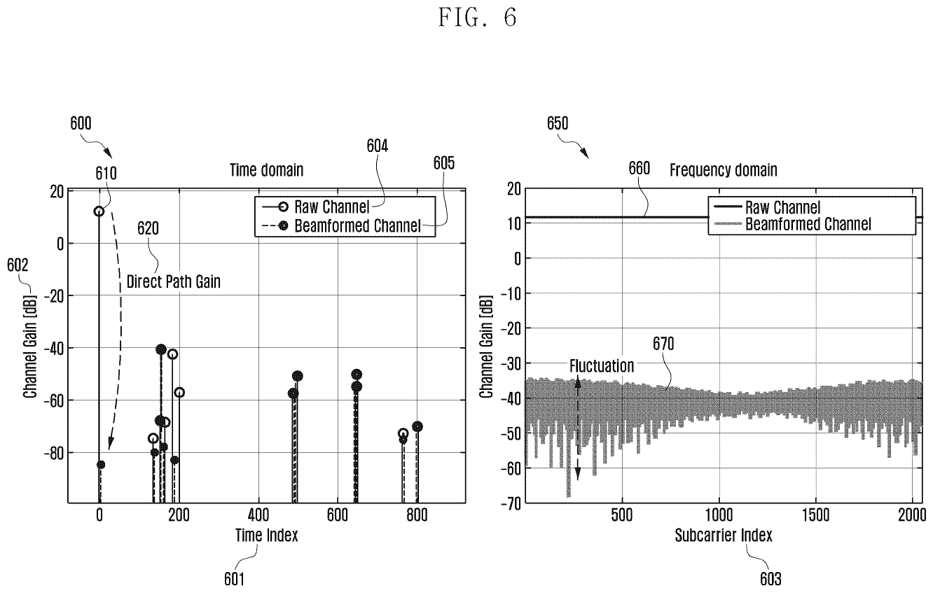

FIG. 6 illustrates graphs 600, 650 of an SI channel in a time domain and a frequency domain in a wireless communication system according to an embodiment.

Referring to FIG. 6, a first graph 600 illustrates an SI channel on the x-axis (time, time index) 601 and the y-axis (channel gain) 602 in the time domain, and a second graph 650 illustrates an SI channel on the x-axis (subcarrier index) 603 and the y-axis (channel gain) 602 in the frequency domain. In the first graph 600 and second graph 650, a solid line 604 indicates a raw channel, which is a channel gain without beamforming, and a dotted line 605 indicates a beamformed channel. The gain of the LoS SI channel may be confirmed at a point where the time index of the first graph 600 is 0. This is because, among the signals received through the multi-channel SI channel, the signal received through the LoS SI channel may be the fastest received signal. In the same context, the gain of the NLoS SI channel may be confirmed at a point where the time index is not 0 since the signal passing through the NLoS SI channel may not be received faster than the signal passing through the LoS SI channel. The signal passing through the NLoS SI channel is received multiple times at different times since the signal transmitted by the transmitter of the base station is received by the receiver of the base station through multiple NLoS SI channels, and the time of the signal received through each NLoS SI channel is different.

The SI channel may change depending on whether beamforming is performed and/or the index value of beamforming changes, and thus the gain (or channel gain) of the SI channel may change.

For example, if beamforming is not used in a beam selection process, the channel gain of the LoS SI channel 610 among the multi path SI channels may be the highest, as shown in the first graph 600. In addition, a channel gain 660 according to a subcarrier index change may always be constant, as shown in the second graph 650. When beamforming is not used, frequency selectivity may not occur.

However, when beamforming 620 is used in the beam selection process, as shown in the first graph 600, the gain of the LoS SI channel may be reduced, but the influence of the NLoS SI channel may be strengthened as the gain of the NLoS SI channel relatively increases. In addition, when beamforming is used, frequency selectivity of the SI channel may occur, as shown in the second graph 650. Since the fluctuations occur differently depending on the subcarrier index change of the second graph 650, it may be seen that frequency selectivity occurs as a result of beamforming.

Even if there is a change in beamforming or the beamforming index value, or even if some NLoS SI channel exists in an actual service area, the LoS SI channel is maintained. That is, regardless of whether beamforming is used or the value of the beamforming index, an SI occurs through the linear distance between the transmitter of the base station and the receiver of the base station. In the first graph 600 in FIG. 6, when the time index of the first graph is 0, the LoS SI channel is maintained regardless of whether beamforming is used, in that the channel gain is still present, regardless of whether beamforming is used, although the channel gain is reduced depending on whether beamforming is used.

Meanwhile, the LoS SI channel before beamforming may be known by the base station because it is based on the physical arrangement of antennas of a transmitter of the base station and the physical arrangement of antennas of a receiver of the base station. In addition, when the base station uses beamforming technology, the base station knows the beamforming index applied to the transmitter and receiver. The base station may also know the LoS SI channel to which beamforming is applied by using the LoS SI channel before beamforming and a beamforming coefficient. Therefore, with respect to FIG. 6, the base station communicating with the UE using the beamforming technology may know the LoS SI channel information among the multiple-path SI channels by using the index of a DL beam for servicing a DL and the index of an UL beam for servicing an UL.

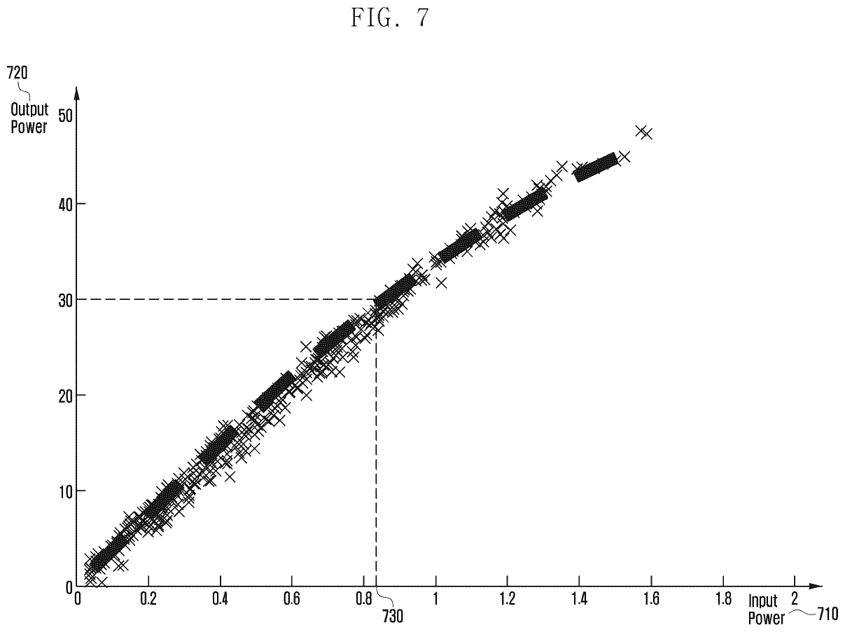

FIG. 7 illustrates a non-linearity occurs in a nonlinear element of a transmitter of the base station in a wireless communication system according to an embodiment.

Referring to FIG. 7, a non-linearity is a property in which a change in output is not proportional to a change in input.

FIG. 7 represents an output power corresponding to an input power of a power amplifier (PA) on the x-axis (input power) 710 and a y-axis (output power) 720. It may be seen that when the input power of the PA is less than or equal to a specific value 730, a change in output is proportional to a change in input, but as the input power exceeds the specific value 730, the change in output decreases to below the change in input and is not proportional. In other words, it may be seen that non-linearity occurs in the PA when the input power is greater than or equal to the specific value 730, and therefore, the PA may be a nonlinear element.

Meanwhile, the base station may include one or more nonlinear elements such as a PA. A signal to be transmitted from a base station passes through at least one nonlinear element to become a signal including non-linearity and is transmitted through antennas of a transmitter of the base station. Therefore, a signal received through an SI channel, which is a channel through which a signal transmitted through a transmitter of the base station is received by a receiver of the base station, may also be a signal including non-linearity.

To perform efficient communication, an SI channel must be estimated, but estimating an SI channel based on a signal including non-linearity may not be efficient. Therefore, there is a need in the art for a method for separately estimating the non-linearity of a signal including non-linearity and estimating an SI channel based on a signal from which the non-linearity is cancelled (or corrected).

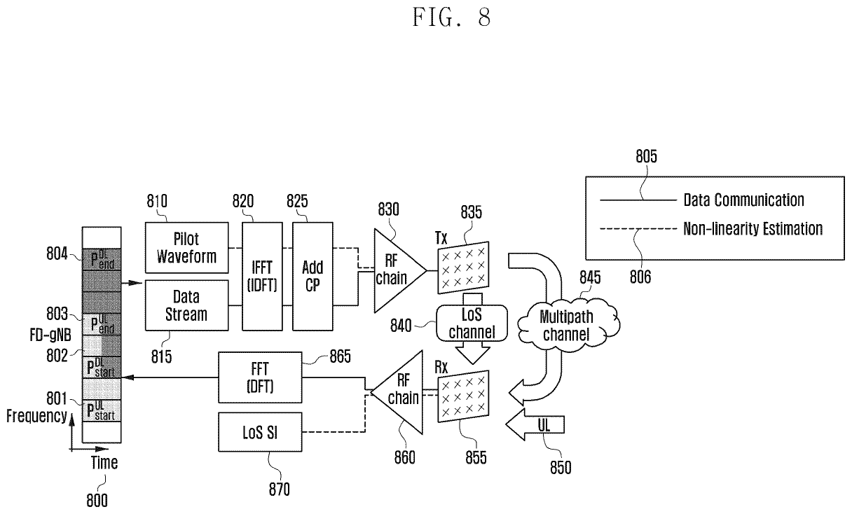

FIG. 8 illustrates a process in which SI including non-linearity occurs and a process for estimating the non-linearity of an SI channel in a wireless communication system according to an embodiment.

In this case, in the SI channel, a signal transmitted from a transmitter of the base station through a base station including a nonlinear element is received by a receiver of the base station. In addition, the non-linearity of the SI channel indicates non-linearity occurring in a signal passing through the SI channel. In addition, the SI channel from which non-linearity is cancelled indicates a channel in which a signal from which non-linearity is cancelled (or corrected) in consideration of the non-linearity of the SI channel is transmitted from a transmitter of the base station and received by a receiver of the base station. Referring to FIG. 8, a resource related to a frequency band 800 used for transmission of at least one of an UL and a DL is shown. When the base station supports flexible duplex communication, the frequency band-related resources corresponding to reference numerals 801 to 803 may be frequency band-related resources used for UL reception, and the frequency band-related resources corresponding to reference numerals 802 to 804 may be frequency band-related resources used for DL transmission. Among these, the frequency band-related resources corresponding to the reference numerals 802 to 803 may be frequency band-related resources used for both UL and DL transmission and reception. After the base station that has completed the flexible duplex communication and the specific UEs are paired, allocation of resource blocks (RBs) may be performed for communication between the specific UEs and the base station.

A path 805 of a data stream 815 transmitted in relation to an SI channel is shown, and a dotted line representing a path 806 of a pilot signal (or pilot waveform) 810 used to estimate the non-linearity of a nonlinear element is also shown.

When the data stream 815 is to be transmitted, the data stream is subjected to an inverse fast Fourier transform (IFFT) 820, a cyclic prefix (CP) is added to the transformed data 825, and the data stream passes through an RF chain 830 and then may be transmitted through an antenna 835 of a transmitter of the base station. The RF chain 830 through which the data stream passes includes nonlinear elements such as a PA. Since the signal transmitted through the antenna 835 of the transmitter of the base station has passed through the RF chain, the transmitted signal may be a transmission signal including non-linearity.

Thereafter, the nonlinear signal transmitted through the antenna 835 of the transmitter of the base station may be received through the antenna 855 of the receiver of the base station through a multi path SI channel 845 including a LoS SI channel 840 together with an UL 850 of a specific UE paired with the receiver of the base station. A nonlinear signal received through the antenna 855 of the receiver of the base station passes through the RF chain 860 of the receiver of the base station, and the signal that has passed through is fast Fourier transformed (FFT) 865, and may reach a baseband processor. That is, as the data stream 815 passes through the path, SI including non-linearity may occur between the transmitter of the base station and the receiver of the base station.

SI may occur with the decoding of the UL 850 received from the UE. Therefore, analog SIC and/or digital SIC may be required for accurate data communication. An SI channel estimation process may be required for the digital SIC. However, the existing SI channel estimation process has a problem in that the computational complexity of the estimation process is high because it estimates non-linearity and SI channel at once.

Disclosed is a two-step SI channel estimation process that separately estimates the non-linearity of an SI channel including non-linearity, and then corrects the non-linearity of a signal to be used to estimate the SI channel, thereby estimating the SI channel with the non-linearity cancelled. A non-linearity correction method according to an embodiment of the disclosure includes a method for generating and transmitting a digital pre-distortion (DPD) or low peak to average power ratio (PAPR) waveform. When the SI channel estimation process according to an embodiment of the disclosure is used, the computational complexity of the SI channel estimation process may be reduced compared to the existing SI channel estimation process.

In FIG. 8, to separately estimate the non-linearity of an SI channel generated from a nonlinear element inside a base station, the base station generates a pilot signal 810 that is subjected to IFFT 820. A CP is added to the transformed pilot signal 825, passes through an RF chain 830, and is transmitted through an antenna 835 of a transmitter of the base station. Thereafter, the pilot signal transmitted through the antenna 835 of the transmitter of the base station may be received through the antenna 855 of the receiver of the base station through the SI channel 850. The pilot signal received through the antenna 855 of the receiver of the base station may reach the base station by passing through the RF chain 860 of the receiver of the base station.

Thereafter, the base station may estimate the non-linearity of the SI channel generated from the nonlinear elements inside the base station based on the LoS SI channel 870 that the base station already knows, the pilot signal delivered internally, and the pilot signal received through the receiver of the base station.

The non-linearity of the SI channel may be expressed as f_{TRx}.

For example, if the DL signal that the base station intends to transmit is defined as x^{DL}, the DL signal x^{NL} including the non-linearity that is actually transmitted from the transmitter of the base station antenna may be expressed as follows in Equation (1).

$${x}^{N L} = {f}_{T R x} ( {x}^{D L} ) \qquad ( 1 )$$

The non-linearity of the SI channel f_{TRx} may be assumed and expressed as a polynomial, and in relation to f_{TRx}^{f}^{_{TRx}} expressed as polynomial, x^{NL} may be expressed as follows in Equation (2).

$${x}^{N L} = {f}_{T R x} ( {x}^{D L} ) = {a}_{1} {x}^{D L} + {a}_{3} {\vert {x}^{D L} \vert}^{2} {x}^{D L} + {a}_{5} {\vert {x}^{D L} \vert}^{4} {x}^{D L} + … + {a}_{2 k + 1} {\vert {x}^{D L} \vert}^{2 k} {x}^{D L} \qquad ( 2 )$$

In addition, if the SI channel is expressed as h^{SI} and the noise is expressed as z, the signal received at the receiver of the base station through the SI channel may be expressed as follows in Equation (3).

$$( 3 )$$

$${y}^{SI} = {h}^{SI} ( {a}_{1} {x}^{D L} + {a}_{3} {\vert {x}^{D L} \vert}^{2} {x}^{D L} + {a}_{5} {\vert {x}^{D L} \vert}^{4} {x}^{D L} + … + {a}_{2 k + 1} {\vert {x}^{D L} \vert}^{2 k} {x}^{D L} ) + z$$

A pilot signal having a specific pilot pattern may be used for non-linearity estimation, and a DMRS may be used for estimation of an SI channel. In addition, the data stream 815 in FIG. 8 may be a DMRS with non-linearity corrected.

Analog SIC and/or digital SIC may be required for smooth data communication between a base station and a UE. An SI channel estimation process may be required for digital SIC. The existing SI channel estimation process has a problem in that the non-linearity and SI channel are estimated at once, resulting in high computational complexity of the estimation process.

Disclosed is a two-step SI channel estimation process that separately estimates the non-linearity of an SI channel including non-linearity, and then corrects the non-linearity to estimate an SI channel with non-linearity cancelled. A non-linearity correction method disclosed herein includes a method for generating and transmitting a DPD or low PAPR waveform. When an SI channel estimation process according to an embodiment of the disclosure is used, the computational complexity of the SI channel estimation process may be reduced compared to the existing SI channel estimation process.

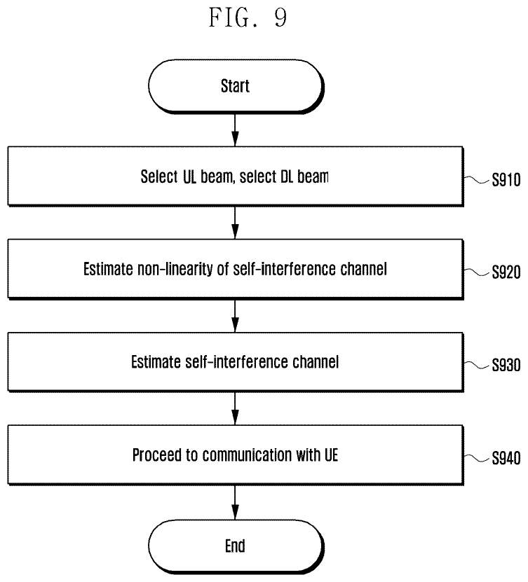

FIG. 9 illustrates a flow chart of a base station communicating with a UE by cancelling SI in a wireless communication system according to an embodiment.

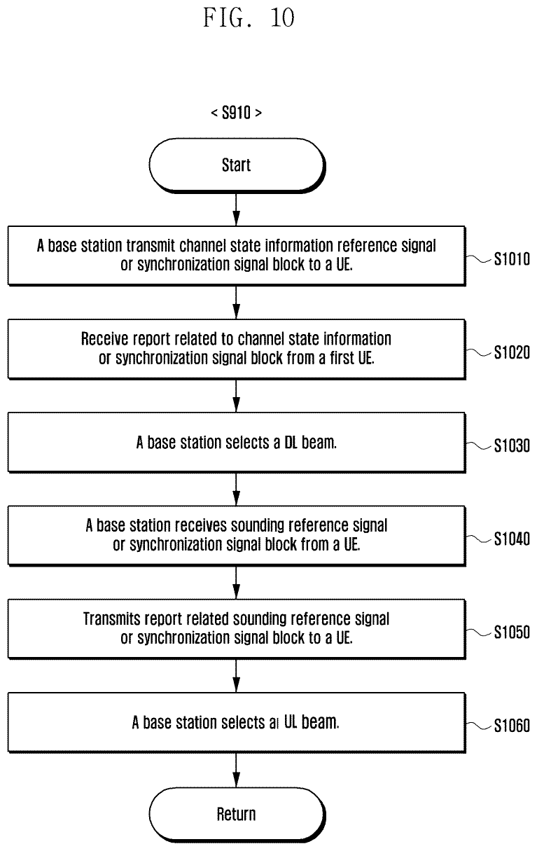

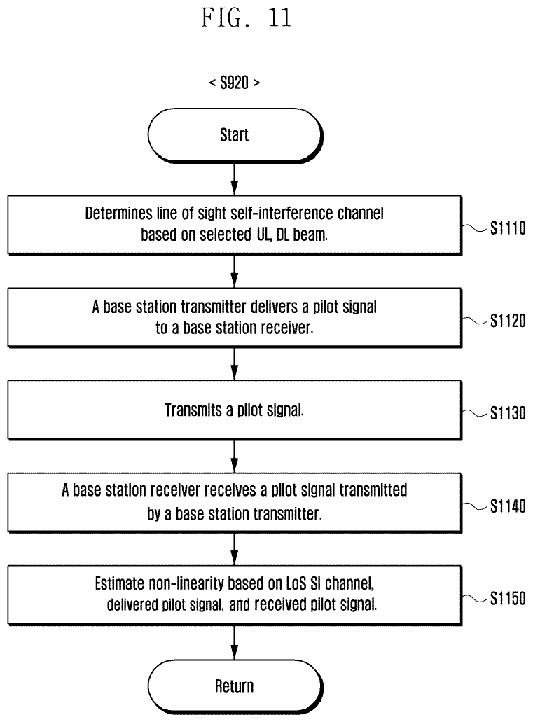

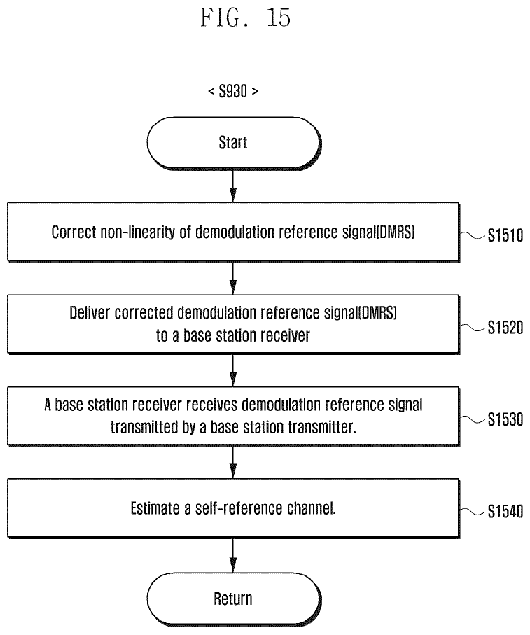

FIG. 9 shows a process of a base station communicating with a UE by cancelling SI. Therefore, detailed operations of step S910 may be illustrated in FIG. 10, detailed operations of step S920 may be illustrated in FIG. 11, and detailed operations of step S930 may be illustrated in FIG. 15, which may be referenced to understand the process of a base station communicating with a UE by cancelling SI.

In step S910, a base station selects a UL beam and DL beam for communicating with a plurality of UEs. The base station in this operation may select a UL beam and DL beam using beamforming technology. In addition, the base station in this step may support flexible duplex communication. Flexible duplex communication may be a technology for communicating by dynamically allocating UL and DL resources for the same frequency band in a specific time zone, and contents related to flexible duplex communication may refer to the contents disclosed in relation to FIG. 1.

In step S920, the base station estimates non-linearity of an SI channel. The non-linearity of the SI channel may be caused by a nonlinear element inside the base station, and the nonlinear element inside the base station may be a PA.

In step S930, the base station may estimate an SI channel. The SI channel in step S930 may be an SI channel from which non-linearity has been cancelled. In step S930, a DMRS may be used, and the DMRS may be a DMRS from which non-linearity has been corrected.

In step S940, the base station may communicate with the UE. A base station supporting flexible duplex communication may communicate with multiple UEs simultaneously, and the communication in step S940 may perform flexible duplex communication by cancelling SI.

FIG. 10 illustrates a flowchart of UL beam selection and DL beam selection operations in a wireless communication system according to an embodiment.

Referring to FIG. 10, in step S1010, the base station may transmit a channel state information reference signal (CSI-RS) or a synchronize signal block (SSB) to a specific UE. The transmitter of the base station may transmit the CSI-RS or SSB, and the specific UE may be a first UE.

In step S1020, the base station may receive a report related to the channel state information (CSI) or synchronize signal block from the UE. The report related to the CSI or SSB may correspond to the CSI-RS or SSB received by the UE from the base station.

In step S1030, the base station may select a DL beam. The base station may select a DL beam based on the report related to CSI or SSB received from the UE. In relation to an embodiment of the disclosure, the base station may select a DL beam using MIMO and beamforming technology.

In step S1040, the base station may receive a sounding reference signal (SRS) or an SSB from a specific UE. In step S1040, the receiver of the base station may receive the SRS or SSB, and the specific UE may be a second UE different from the first UE in step S1010.

In step S1050, the base station may transmit a report related to the SRS or SSB to the UE of step S1040. The report related to the SRS or SSB may correspond to the SRS or SSB received from the second UE.

In step S1060, the base station may select a UL beam. The base station may select the UL beam based on the report related to the SRS or synchronization signal block transmitted to the UE. In an embodiment of the disclosure, the base station may select the UL beam using MIMO and beamforming technology.

FIG. 11 is a flowchart illustrating an operation of estimating the non-linearity of an SI channel in a wireless communication system according to an embodiment.

Referring to FIG. 11, in step S1110, a base station may determine an LoS SI channel. The LoS SI channel before beamforming may be determined by the base station based on the physical arrangement of the antennas of a transmitter of the base station and the physical arrangement of the antennas of a receiver of the base station. In addition, since the base station may determine a beamforming coefficient to be applied to the transmitter and receiver, the base station may also determine an LoS SI channel to which beamforming is applied. Accordingly, the base station may determine an LoS SI channel based on existing information regardless of whether beamforming technology is applied.

In step S1120, the transmitter of the base station may deliver a pilot signal to the receiver of the base station. Delivering a pilot signal is a concept distinct from transmitting and receiving a pilot signal, and may be delivering information related to a signal internally in the base station. The pilot signal may include a parameter Ω related to a pilot pattern, and/or a parameter A_{digi} related to the power of the pilot signal. The disclosed pilot signal delivery is similar to the process of indicating the pattern of the pilot signal, or transmitting a reference signal pattern indicator.

In step S1130, the transmitter of the base station may transmit the pilot signal. The pilot signal may be a signal generated based on a pilot pattern determined by the base station. The pilot pattern may be determined according to the length of an SI channel to be estimated. In this case, the length of the SI channel may refer to a time difference in a time domain between the latest arriving signal and the earliest arriving signal, among the signals reaching the base station through the multi path SI channel.

In step S1140, the receiver of the base station may receive the pilot signal transmitted by the transmitter of the base station. The transmitter of the base station may have transmitted the pilot signal to the UE, but it may have been delivered to the receiver of the base station through the SI channel, and the receiver of the base station may have received the pilot signal.

In step S1150, the non-linearity of the SI channel may be estimated based on the delivered pilot signal, the LoS SI channel determined by the base station, and the pilot signal received through the SI channel. The non-linearity of the SI channel may be generated by a nonlinear element inside the base station.

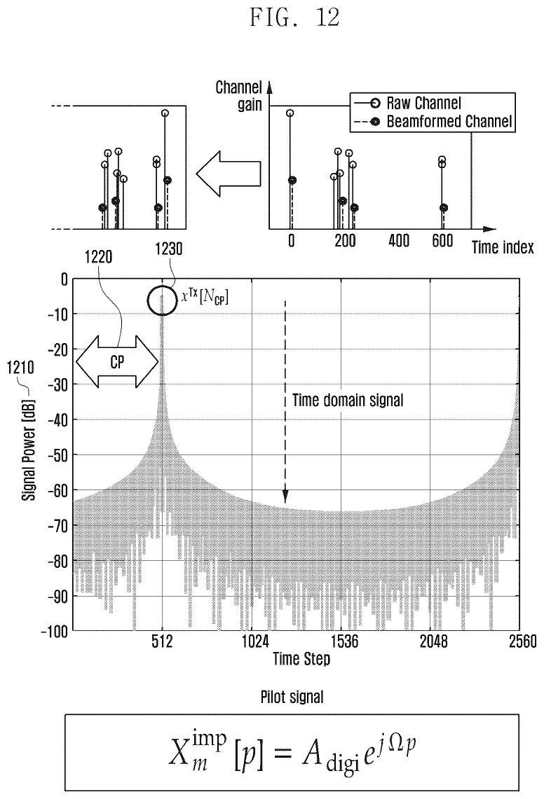

FIG. 12 illustrates a pilot signal according to an embodiment.

Referring to FIG. 12, a graph is illustrated representing a pilot signal 1210 on the x-axis (time, time step) and the y-axis (signal power) according to an embodiment. Time steps 0 to 511 in the graph 1210 may be a CP 1220, which is a signal copied from the last section of a valid symbol section and inserted at the beginning of the signal to prevent interference between channels.

A pilot signal may have a form of an impulse function. An impulse function may be a function having a signal power greater than or equal to a specific size in a specific time domain. For example, a pilot signal illustrated in a reference numeral 1210 may be a pilot signal having an impulse function form because, when a time domain is around 512, a signal power is greater than or equal to −10 decibels (dB), and when a time domain is not around 512, a signal power is less than or equal to −10 Db. Among the pilot signals expressed in a time domain in the disclosure, a part 1230 indicating the maximum signal power may be referred to as a peak.

A pilot signal may be determined based on amplitude and periodicity. That is, the pilot signal may show a form in which the maximum signal power increases as the amplitude increases. As the periodicity of the pilot signal decreases, the impulse shape of the pilot signal may be expressed in a form that returns with a shorter period. For example, as the amplitude of the pilot signal increases, the power of the signal may increase when a time domain is around 512, and when the periodicity of the pilot signal is shortened by two times, the impulse shape may appear twice between time steps 0 and 2560. The power of the pilot signal may be proportional to the square of the amplitude of the pilot signal.

The pilot signal may be expressed as follows in Equation (4).

$${X}_{m}^{imp} [ p ] = {A}_{digi} {e}^{j Ω p} \qquad ( 4 )$$

In Equation (4), Xₘ^{imp} may be the pilot signal 1210, p may be a subcarrier, A_{digi} may be the amplitude of the pilot signal, and Ω may be the periodicity of the pilot signal 1210.

A signal 1250 is received through a multi path SI channel on the x-axis (time index) and the y-axis (channel gain). The LoS SI channel gain may be confirmed where the time index of 1250 is 0 since, among the signals received through the multi-channel SI channel, the signal received through the LoS SI channel is the fastest received signal. In the same context, the gain of the NLoS SI channel may be confirmed where the time index is not 0 since the signal passing through the NLoS SI channel may not be received faster than the signal passing through the LoS SI channel.

The pilot signal transmitted by a transmitter of the base station may be received by a receiver of the base station via a multi path SI channel. In this case, the pilot signal received via an NLoS SI channel may only be at a noise level. That is, a pilot signal received via an NLoS SI channel may be at a negligible level. On the other hand, the pilot signal received via an LoS SI channel may be a signal with a significant power.

For example, as illustrated in FIG. 12, a pilot signal including a peak 1230 may be received by a receiver of the base station via an LoS SI channel 1251. In this case, the pilot signal received by the receiver of the base station may be a signal with a significant power. However, the pilot signal not including the peak 1230 may be received by a receiver of the base station via an NLoS SI channel 1252, and the power of the pilot signal not including the peak may only be at a noise level.

As another example, at a specific point in time, a signal passing through an LoS channel and a signal passing through an NLoS channel may be simultaneously received by a receiver of the base station. Among them, the signal passing through the LoS channel may be regarded as a main signal because it may include a peak. The signal passing through the NLoS channel may be regarded as a noise level because it does not include a peak.

Since the pilot signal received through the NLoS SI channel may be disregarded, the receiver of the base station may receive a pilot signal passing only through the LoS SI channel.

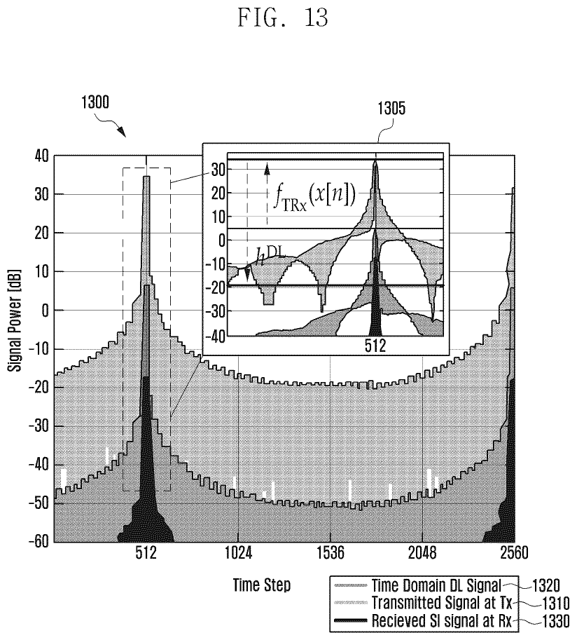

FIG. 13 illustrates a process for deriving non-linearity of a pilot signal according to an embodiment.

Referring to FIG. 13, a graph 1300 illustrates a pilot signal 1310, a pilot signal 1320 transmitted from a transmitter of the base station, and a pilot signal 1330 received from a receiver of the base station on the x-axis (time, time step) and the y-axis (signal power). An enlarged view 1305 illustrates a related shape around time step 512. In this case, time steps 0 to 511 of 1300 may be a CP.

A base station initially intends to transmit the pilot signal 1310, and the pilot signal 1310 does not exhibit non-linearity and may corresponds to a selected pilot pattern. The pilot signal 1320 transmitted from the transmitter of the base station is actually transmitted from the antennas of the transmitter of the base station, and includes non-linearity that occurs when the pilot signal in the time domain passes through a nonlinear element inside the base station. In addition, the pilot signal 1330 received by the receiver of the base station includes non-linearity that has been actually transmitted by the transmitter of the base station and received through an SI channel. In this case, the nonlinear element inside the base station may be a PA, and the SI channel may be a multi path SI channel including an LoS SI channel and an NLoS SI channel.

In other words, the pilot signal 1310 may be converted into a pilot signal including non-linearity while passing through the nonlinear element inside the base station and delivered to the antennas of the transmitter of the base station, and the pilot signal 1320 transmitted from the antennas of the transmitter of the base station may be received by the antennas of the receiver of the base station through the LoS SI channel and the NLoS SI channel.

In FIG. 13, the base station has attempted to transmit the pilot signal 1310, but the pilot signal 1330 received by the receiver of the base station may have been received depending on the non-linearity inside the base station, the state of the SI channel, etc. The base station may estimate the non-linearity of the SI channel based on the pilot signal 1330 received by the receiver of the base station, the LoS SI channel previously determined, and the delivered pilot signal. In this case, the delivered pilot signal may be one that the transmitter of the base station has internally delivered to the receiver of the base station, and may be the same signal as the pilot signal 1310 that has been targeted to be transmitted.

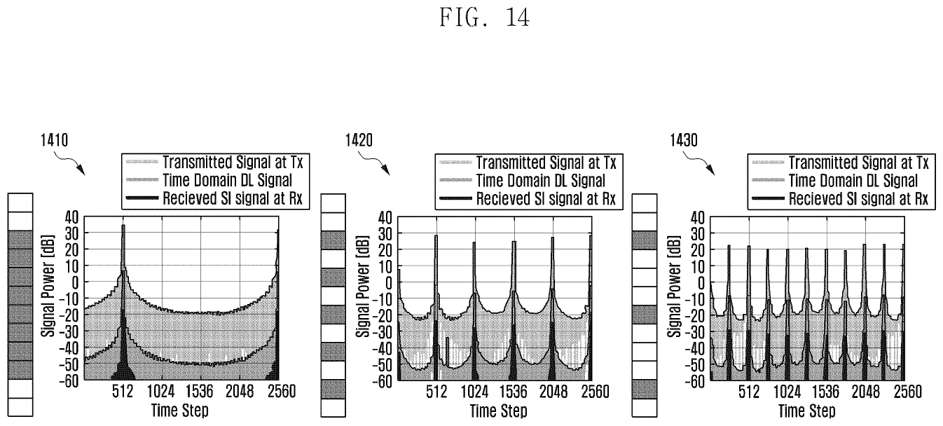

FIG. 14 illustrates various types of pilot patterns according to an embodiment.

Referring to FIG. 14, a diagram 1400 illustrates continuous arrangement of pilot signals on all subcarriers and pilot signals corresponding thereto, a diagram 1420 illustrates continuous arrangement of pilot signals on carriers having even or odd indices and pilot signals corresponding thereto, and a diagram 1430 illustrates arrangement of pilot signals on every four subcarriers and pilot signals corresponding thereto. Diagrams 1410, 1420, and 1430 may be referred to as different pilot patterns of pilot signals. For example, 1410 may be expressed as illustrating a pilot signal according to pilot pattern 1. A signaling overhead burden may be reduced as the subcarrier arrangement interval is decreased, and a signaling overhead burden may be increased as the subcarrier arrangement interval is increased.

Depending on the subcarrier arrangement, the corresponding pilot signals may vary. For example, the fact that the pilot signals of 1410, 1420, and 1430 are different may be due to the different subcarrier arrangements.

As spacing between the subcarriers decreases, the periodicity of the pilot signals according to the corresponding pilot pattern may increase. The periodicity of the pilot signals may be the same as the occurrence periodicity of the peaks of the pilot signals. A longer periodicity of the pilot signals indicates that fewer peaks according to the impulse shape appear within a specific time.

For example, the periodicity of the pilot signal of 1410 may be 2048, the periodicity of the pilot signal of 1420 may be 512, and the periodicity of the pilot signal of 1430 may be 256. Also, 1410 may be a pilot pattern in which a peak appears once in a time step of 2560, 1420 may be a pattern in which a peak appears five times in a time step of 2560, and 1430 may be a pattern in which a peak appears ten times in a time step of 2560. Therefore, the periodicity of the pilot signal illustrated in 1410 may be the longest, and the periodicity of the pilot signal illustrated in 1430 may be the shortest.

When the spacing between subcarriers is narrowed, the signal power at the peak may increase. A strong signal power at the peak indicates that its value is large when the signal power is expressed in dB units. For example, the signal power at the peak of 1410 is about 35 dB, the signal power at the peak of 1420 is about 30 dB, and the signal power at the peak of 1430 is about 20 dB, so it can be seen that the signal power at the peak of 1410 is the strongest, and the signal power at the peak of 1430 is the weakest.

When the length of the SI channel to be estimated is short, it may be efficient to select a pilot pattern corresponding to a pilot signal with a short periodicity. In this case, the length of the SI channel indicates a time difference in a time domain between the latest arriving signal and the earliest arriving signal, among the signals reaching a base station through multi path SI channel.

When the periodicity of the pilot signal is shorter than the length of the SI channel to be estimated, the estimation of the SI channel may become difficult. For example, when the length of the SI channel to be estimated is time step 1024, the pilot signal illustrated in 1410 may be used, but the pilot signals illustrated in 1420 and 1430 may not be used.

Through the three patterns in FIG. 14, the periodicity of the pilot signal and the power of the signal at the peak may change according to a change in the arrangement of the subcarriers. Therefore, an appropriate pilot pattern may be selected by considering the length of the SI channel to be estimated, the periodicity of the pilot signal, and signaling overhead.

FIG. 15 illustrates a flow chart of a SI channel estimation operation in a wireless communication system according to an embodiment.

Referring to FIG. 15, a DMRS r(n) may be defined as follows in Equation (5).

$$r ( n ) = \frac{1}{\sqrt{2}} ( 1 - 2 \cdot c ( 2 n ) ) + j \frac{1}{√ 2} ( 1 + 2 \cdot c ( 2 n + 1 ) ) \qquad ( 5 )$$

The initial value cᵢₙᵢₜ of the pseudo-random sequence c of Equation (5) may be determined as follows in Equation (6).

$$( 6 )$$

$${c}_{init} = ( {2}^{17} ( {N}_{symb}^{slot} {n}_{s , f}^{μ} + l + + 1 ) ( 2 {N}_{ID}^{{n}_{SCID}} + 1 ) + 2 {N}_{ID}^{{n}_{SCID}} + {n}_{SCID} ) mod {2}^{31}$$

In Equation (6), l is an OFDM symbol number within a slot, and n_{s,f}^{μ} is a slot number within a frame. With respect to N_{ID}^{nSCID} , when higher layer parameters scramblingID0 and scramblingID1 are provided in DMRS-DownlinkConfig IE, natural numbers N_{ID}⁰, and N_{ID}¹ among 0 and 65535 are given, and in this case, physical DL shared channel (PDSCH) is scheduled by PDCCH using DL control information (DCI) format 1_1, together with cyclic redundancy check (CRC) scrambled by cell-radio network temporary identifier (C-RNTI) or configured scheduling-radio network temporary identifier (CS-RNTI). In addition, in relation to N_{ID}^{nSCID}, when the higher layer parameter scramblingID0 is provided in the DMRS-DownlinkConfig IE, a natural number N⁰_{ID} between 0 and 65535 is given. In this case, the PDSCH is scheduled by the PDCCH using DCI format 1_0, together with the CRC scrambled by the C-RNTI or CS-RNTI. When the higher layer parameter scramblingID0 or scramblingID1 is not provided, N_{ID}^{nSCID} is N_{ID}^{cell}. Based on the initial value cᵢₙᵢₜ of the pseudo-random sequence c calculated in Equation (6) through the above parameters, the DMRS r(n) of Equation (5) may be calculated.

In step S1510, a base station may correct a non-linearity of a DMRS. A non-linearity correction method according to an embodiment of the disclosure includes a method for generating and transmitting a DPD or low PAPR waveform.

In step S1520, the base station may deliver the corrected DMRS to a receiver of a base station. The entity of delivering the corrected DMRS may be a transmitter of the base station. Delivering the DMRS is a concept that is distinct from transmitting and receiving the DMRS, and may be delivering information related to the DMRS internally in the base station.

In step S1530, the receiver of the base station may receive the DMRS transmitted by transmitter of the base station. In this case, the transmitter of the base station may have attempted to transmit the DMRS to a UE, but it may have been delivered to the receiver of the base station through an SI channel, and then the receiver of the base station may have received the DMRS.

In step S1540, the base station may estimate the SI channel from which non-linearity has been cancelled. The SI channel from which non-linearity has been cancelled estimated by the base station may be estimated based on the delivered corrected DMRS and the corrected DMRS received through the receiver of the base station.

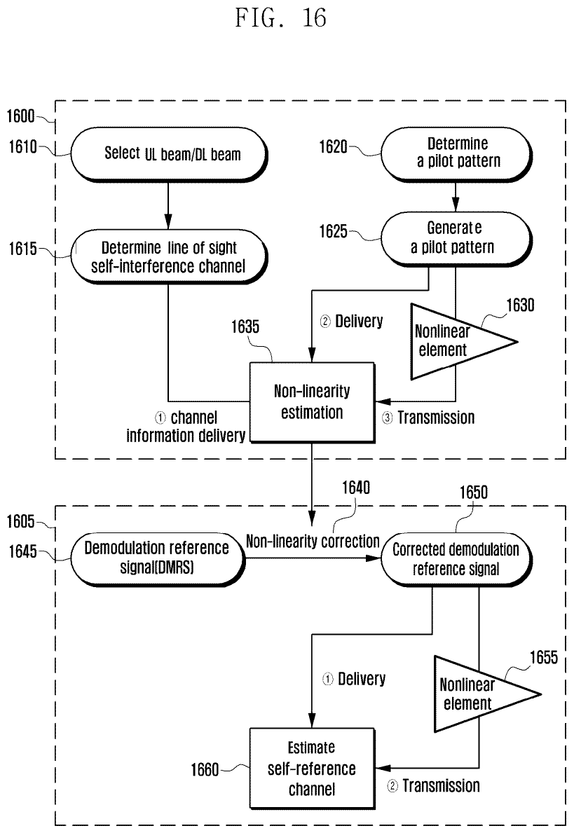

FIG. 16 illustrates an overall process of estimating non-linearity of a pilot signal 1600 and estimating an SI channel based on the non-linearity 1605 in a wireless communication system according to an embodiment.

Referring to FIG. 16, in process 1600, a UL beam and DL beam are selected in step 1610. The selection of the UL beam and the DL beam may be related to the contents disclosed in FIG. 10.

In step 1615, a base station determines an LoS SI channel based on the selected UL beam and DL beam. A beamforming coefficient may be considered when determining the LoS self-interference channel.

In step 1620, the base station determines a pilot pattern. The determination of the pilot pattern may be related to the contents disclosed in FIG. 14. Therefore, for detailed description related to 1620, reference may be made to the description of FIG. 14.

In step 1625, the base station may generate a pilot signal based on the determined pilot pattern. The pilot signal may be related to the contents disclosed in FIG. 12 and FIG. 13.

In step 1635, the base station may estimate non-linearity of the pilot signal based on the delivered self-interference channel information (\textcircled{1}), the delivered pilot signal (\textcircled{2}), and the transmitted pilot signal (\textcircled{3}).

The delivered SI channel information may be LoS SI channel information, the delivered pilot signal may be delivered through the inside of the base station, and the transmitted pilot signal may be transmitted from the transmitter of base station to the receiver of the base station through the SI channel.

In this case, the pilot signal transmitted from the transmitter of the base station to the base station receiver through the SI channel may have passed through a nonlinear element 1630 inside the base station. Therefore, the transmitted pilot signal may be a pilot signal including non-linearity.

In process 1605, the base station in step 1640 may correct the non-linearity of the DMRS 1645DMRS, which may be referred to as a corrected DMRS 1650.

In step 1660, the base station may estimate the SI channel based on the delivered corrected DMRS and the transmitted corrected DMRS. In this case, the transmitted corrected DMRS may have passed through a nonlinear element inside the base station. Since previously the DMRS has been corrected in consideration of the occurrence of non-linearity, even if the corrected DMRS is a signal that has passed through a nonlinear element inside the base station, the corrected DMRS received by the base station receiver may not have non-linearity.

Based on the SI channel estimated at 1660, the base station may perform SIC. In this case, the SIC performed by the base station may be digital SIC. Through SIC, the base station may receive a UL with less interference. Therefore, the base station may perform smooth data communication with the UE.

Table 1 below describes estimation parameters, estimation methods, and differences between the method in the disclosure and the existing method with respect to SI channel estimation according to an embodiment.

TABLE 1

| Process | Disclosed Scheme | | Conventional Scheme |
|---|---|---|---|
| | Non-linearity | SI channel | Simultaneous estimation of |
| | estimation | estimation | nonlinear and SI channels |
| Estimation parameters | Nonlinear coefficient (a₃, a₅, . . . , a_{2K +} ₁) | SI channel (H[1], H[2], . . . , H[P]) | Combination of nonlinear coefficients and SI channels $( [ \begin{matrix}{C}_{1} [ 1 ] & {C}_{1} [ 2 ] & … & {C}_{1} [ P ] \\ {C}_{3} [ 1 ] & {C}_{3} [ 2 ] & … & {C}_{3} [ P ] \\ ⋮ & ⋮ & ⋱ & ⋮ \\ {C}_{2 K + 1} [ 1 ] & {C}_{2 K + 1} [ 2 ] & … & {C}_{2 K + 1} [ P ]\end{matrix} ] )$ |
| Number of | K | P | K*P |
| estimation | | | |
| parameters | | | |
| Estimation | First, the non- | SI channel | SI channels including nonlinearities |
| method | linearity of the | is estimated based | are estimated at once |
| | SI channel is estimated | on DMRS with | |
| | based on a proposed | non-linearity | |
| | pilot signal. | correction | |
| Difference | A LOS SI channel and | Correct via | No separate estimation of non- |
| | pilot signal are used. | estimated | linearity is required to estimate SI |
| | | non-linearity | channels. |

With reference to Table 1, in the conventional scheme, non-linearity and SI channel are estimated simultaneously to estimate SI channel. Therefore, in the conventional scheme, the computational complexity for calculating SI channel is K (the number of nonlinear coefficients)*P (the number of subcarriers in the OFDM method).

In the disclosed method, non-linearity and SI channel are estimated separately to estimate SI channel, so the computational complexity for calculating SI channel is K (the number of nonlinear coefficients)+P (the number of subcarriers in the OFDM method). The disclosed method has the characteristic of lowering the computational complexity required to estimate SI channel in general compared to the conventional scheme.

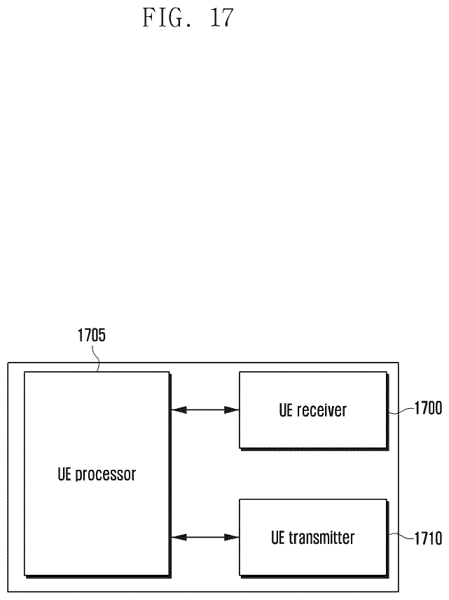

FIG. 17 illustrates a structure of a UE in a wireless communication system according to an embodiment.

Referring to FIG. 17, a UE may include a transceiver, which refers to a UE receiver 1700 and a UE transmitter 1710, a memory, and a UE processor 1705 (or UE controller or processor). The UE transceiver 1700, 1710, memory, and UE processor 1705 may operate according to the aforementioned communication method of the UE. However, elements of the UE are not limited to the aforementioned examples. For example, the UE may include more or fewer elements than the aforementioned elements. Furthermore, the transceiver, memory, and processor may be implemented as a single chip.

The transceiver may transmit and receive a signal to and from a base station. The signal may include control information and data. To this end, the transceiver may include an RF transmitter that up-converts and amplifies a frequency of a signal to be transmitted, an RF receiver that low-noise-amplifies a received signal and down-converts a frequency of the received signal, and the like. However, this is only an embodiment of the transceiver, and the elements of the transceiver are not limited to the RF transmitter and the RF receiver.

Also, the transceiver may receive a signal through a wireless channel and output the signal to the processor, and may transmit a signal output from the processor, through a wireless channel.

The memory may store programs and data that are required for operations of the UE. The memory may also store control information or data included in a signal transmitted and received by the UE. The memory may include a storage medium such as read-only memory (ROM), random access memory (RAM), hard-disk, compact disc (CD)-ROM, digital versatile disc (DVD), etc., or a combination thereof. Furthermore, the memory may include a plurality of memories.

In addition, the processor may control a series of processes so that the UE operates according to the disclosed embodiments. For example, the processor may perform the operations of receiving configuration information including a dual channel coding parameter from the base station, wherein the dual channel coding parameter includes information indicating a number of source code blocks, receiving DL control information including resource allocation information from the base station, receiving, from the base station, data to which the dual channel coding is applied based on the resource allocation information, and decoding the data based on information related to the number of the source code blocks.

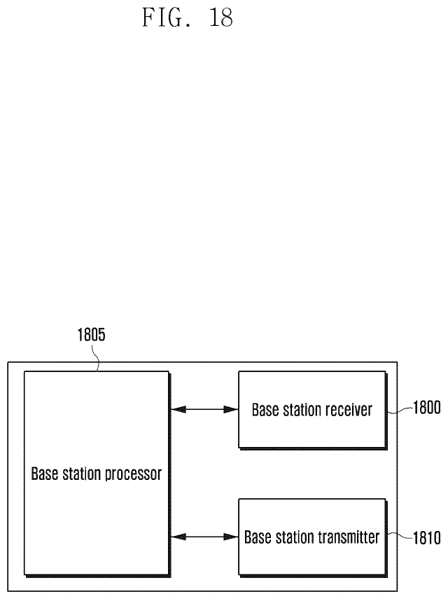

FIG. 18 illustrates a structure of a base station in a wireless communication system according to an embodiment.

With reference to FIG. 18, a base station may include a transceiver, which refers to a receiver of the base station 1800 and a transmitter of the base station 1810, a memory, and a base station processor 1805 (or base station controller or processor). The base processor may have the same meaning as a base station baseband processor. The base station transceiver 1800, 1810, memory, and base station processor 1805 may operate according to the aforementioned communication method of the base station. In this case, the base processor 1805 may have the same meaning as a base station baseband processor. However, elements of the base station are not limited to the aforementioned examples. For example, the base station may include more elements than the aforementioned elements or may include fewer elements than the aforementioned elements. The transceiver, memory, and processor may be implemented as a single chip.

The transceiver may transmit and receive a signal to and from a UE. The signal may include control information and data. To this end, the transceiver may include an RF transmitter that up-converts and amplifies a frequency of a signal to be transmitted, an RF receiver that low-noise-amplifies a received signal and down-converts a frequency of the received signal, and the like. However, this is only an embodiment of the transceiver, and the elements of the transceiver are not limited to the RF transmitter and the RF receiver.

The transceiver may receive a signal through a wireless channel and output the signal to the processor, and may transmit a signal output from the processor, through a wireless channel.

The memory may store programs and data that are required for operations of the UE. The memory may also store control information or data included in a signal transmitted and received by the base station. The memory may include a storage medium such as ROM, RAM, hard-disk, CD-ROM, DVD, etc., or a combination thereof. The memory may include a plurality of memories.

The processor may control a series of processes so that the base station operates according to the aforementioned embodiments of the disclosure. For example, the processor may perform the operations of transmitting configuration information including a dual channel coding parameter to the UE, wherein the dual channel coding parameter includes information indicating a number of source code blocks, transmitting DL control information including resource allocation information to the UE, and transmitting, to the UE, data to which the dual channel coding is applied based on the resource allocation information. The data to which the dual channel coding is applied may be characterized in that it corresponds to a coded code block to which network coding is applied to the source code block.

The methods according to the disclosure may be implemented in hardware, software, or a combination of hardware and software.

When the methods are implemented in software, a computer-readable storage medium storing one or more programs (e.g., a software module) may be provided. The one or more programs stored in the computer-readable storage medium may be configured for execution by the one or more processors in an electronic device. The one or more programs may include instructions that cause the electronic device to execute the methods according to the disclosure.

As used in the embodiments, the term “unit” refers to a software or a hardware components, such as a field programmable gate array (FPGA) or an application specific integrated circuit (ASIC), and unit performs a predetermined function. However, the unit does not always have a meaning limited to software or hardware. The unit may be constructed either to be stored in an addressable storage medium or to execute one or more processors. Therefore, the unit includes components such as software components, object-oriented software components, class components, and task components, processes, functions, properties, procedures, sub-routines, segments of a program code, drivers, firmware, micro-codes, circuits, data, database, data structures, tables, arrays, and parameters. The components and functions provided by the unit may be either combined into fewer components and a unit, or divided into additional components and a unit. Moreover, the components and units may be implemented to execute one or more CPUs within a device or a security multimedia card, and the unit may include one or more processors.

Herein, each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart block(s).

Each block may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The programs (e.g., software modules or software) may be stored in random access memory (RAM), a non-volatile memory including a flash memory, read only memory (ROM), electrically erasable programmable ROM (EEPROM), a magnetic disc storage device, compact disc-ROM (CD-ROM), digital versatile discs (DVDs), other types of optical storage devices, or a magnetic cassette. Alternatively, the programs may be stored in a memory that is constituted as a combination of some or all of the memories. Also, each of the memories may include a plurality of memories.

Furthermore, the program may be stored in an attachable storage device that may be accessed through communication networks such as the Internet, Intranet, a local area network (LAN), a wide LAN (WLAN), or a storage area network (SAN) or a communication network configured in a combination thereof. The storage device may access a device performing the embodiments of the disclosure via an external port. A separate storage device on the communication network may also access the device performing the embodiments of the disclosure.

In the aforementioned embodiments of the disclosure, an element or elements included in the disclosure are expressed in a singular or plural form depending on the described embodiments of the disclosure. However, singular or plural expressions are selected appropriately for the presented situations for convenience of description, and the disclosure is not limited to the singular or plural form. An element expressed in a singular form may be configured as a plurality of elements, and elements expressed in a plural form may be configured as a single element.

Meanwhile, the embodiments of the disclosure disclosed in the present specification and drawings are only particular examples for clearly describing the technical aspects of the disclosure and helping understanding of the disclosure, and are not intended to limit the scope of the disclosure. Particularly, it would be obvious to one of skill in the art that other modifications based on the technical spirit of the disclosure may be implemented. In addition, the above-described respective embodiments may be combined with one another and operated as necessary. For example, in the disclosure, parts of one embodiment and parts of another embodiment may be combined to operate a base station and a UE. For example, parts of the first and second embodiments of the disclosure may be combined to operate a base station and a UE. Also, although the above embodiments have been presented based on a frequency division duplex (FDD) LTE system, other modified examples based on the technical ideas of the above embodiments may also be implemented in other systems such as a time division duplex (TDD) LTE system, a 5G system, or a NR system.

Meanwhile, an order of explanation on the drawings describing the methods of the disclosure does not necessarily correspond to an order of execution, and the order of operations may be changed or operations may be performed in parallel.

In addition, the drawings describing the methods of the disclosure may omit some components or may include only some component without departing from the essence of the disclosure.

In addition, the methods of the disclosure may be executed in combination of a part or all of the contents included in the respective embodiments without departing from the essence of the disclosure.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method for a base station supporting flexible duplex communication by dynamically allocating uplink and downlink resources for the same frequency band in a wireless communication system, the method comprising:
transmitting a pilot signal for estimating non-linearity of a self-interference (SI) channel through which a signal transmitted by the base station is received by the base station;
estimating non-linearity of the SI channel based on the pilot signal received through the SI channel;
correcting and transmitting a demodulation reference signal (DMRS), which is used for demodulating a signal received by a terminal from the base station, based on the estimated non-linearity of the SI channel;
estimating the SI channel based on the corrected DMRS received through the SI channel; and
performing communication with a plurality of terminals by cancelling SI based on the estimated SI channel.

2. The method of claim 1,
wherein the pilot signal is based on an impulse function having a signal power greater than or equal to a specific size in a specific time domain.

3. The method of claim 1, wherein the pilot signal is determined based on amplitude and periodicity.

4. The method of claim 1, wherein the pilot signal is expressed by the following Equation,
Xₘ^{imp}[p]=A_{digi}e^{jΩp},
wherein Xₘ^{imp} is the pilot signal, p is a subcarrier, A_{digi} is an amplitude of the pilot signal, and Ω is a periodicity of the pilot signal.

5. The method of claim 1, wherein estimating the non-linearity of the SI channel further includes:
determining a line of sight (LoS) SI channel of the SI channel;
delivering the pilot signal by a transmitter of the base station to a receiver of the base station;
receiving, from the receiver of the base station, the pilot signal transmitted by the transmitter of the base station through the SI channel; and
estimating the non-linearity of the SI channel based on the line of sight SI channel, the delivered pilot signal, and the pilot signal received through the SI channel.

6. The method of claim 1, wherein the estimating the SI channel further includes:
delivering a corrected DMRS from a transmitter of the base station to a receiver of the base station;
receiving, by the receiver of the base station, the corrected DMRS transmitted from the transmitter of the base station through the SI channel; and
estimating the SI channel based on the delivered corrected DMRS and the corrected DMRS received through the SI channel.

7. The method of claim 1,
wherein the pilot signal is generated based on a pilot pattern associated with a periodicity of the pilot signal,
wherein the pilot pattern is determined according to a length of the estimated SI channel and an arrangement of a subcarrier in a frequency domain,
wherein a periodicity of the pilot signal according to the pilot pattern increases as the length of the estimated SI channel increases, and
wherein the periodicity of the pilot signal according to the pilot pattern increases as a spacing of the arrangement of the subcarrier decreases.

8. A base station supporting flexible duplex communication by dynamically allocating uplink and downlink resources for the same frequency band in a wireless communication system, the base station comprising:
a transceiver; and
a controller coupled with the transceiver and configured to:
transmit a pilot signal for estimating non-linearity of a self-interference (SI) channel through which a signal transmitted by the base station is received by the base station,
estimate non-linearity of the SI channel based on the pilot signal received through the SI channel,
correct and transmit a demodulation reference signal (DMRS), which is used for demodulating a signal received by a terminal from the base station, based on the estimated non-linearity of the SI channel,
estimate the SI channel based on the corrected DMRS received through the SI channel, and
perform communication with a plurality of terminals by cancelling SI based on the estimated SI channel.

9. The base station of claim 8,
wherein the pilot signal is based on an impulse function having a signal power greater than or equal to a specific size in a specific time domain.

10. The base station of claim 8,
wherein the pilot signal is determined based on amplitude and periodicity.

11. The base station of claim 8, wherein the pilot signal is expressed by the following Equation,
Xₘ^{imp}[p]=A_{digi}e^{jΩp},
wherein Xₘ^{imp} is the pilot signal, p is a subcarrier, A_{digi} is an amplitude of the pilot signal, and Ω is a periodicity of the pilot signal.

12. The base station of claim 8, wherein an estimation of the non-linearity of the SI channel further includes:
determining a line of sight (LoS) SI channel of the SI channel,
delivering the pilot signal by a transmitter of the base station to a receiver of the base station,
receiving, from the receiver of the base station, the pilot signal transmitted by the transmitter of the base station through the SI channel, and
estimating the non-linearity of the SI channel based on the line of sight SI channel, the delivered pilot signal, and the pilot signal received through the SI channel.

13. The base station of claim 8, wherein an estimation of the SI channel further includes:
delivering a corrected DMRS from a transmitter of the base station to a receiver of the base station;
receiving, by the receiver of the base station, the corrected DMRS transmitted from the transmitter of the base station through the SI channel; and
estimating the SI channel based on the delivered corrected DMRS and the corrected DMRS received through the SI channel.

14. The base station of claim 8,
wherein the pilot signal is generated based on a pilot pattern associated with a periodicity of the pilot signal,
wherein the pilot pattern is determined according to a length of the estimated SI channel and an arrangement of a subcarrier in a frequency domain,
wherein a periodicity of the pilot signal according to the pilot pattern increases as the length of the estimated SI channel increases, and
wherein the periodicity of the pilot signal according to the pilot pattern increases as a spacing of the arrangement of the subcarrier decreases.
